(19) United States
(12) Patent Application Publication
(10) Pub. No.: US 2002/0117340 A1
(43) Pub. Date: Aug. 29, 2002

(54) Laser radar based collision avoidance system for stationary or moving vehicles, automobiles, boats and aircraft

(76) Inventor: Roger Stettner, Santa Barbara, CA (US)

Correspondence Address: GOTTLIEB RACKMAN & REISMAN PC, 270 MADISON AVENUE, 8TH FLOOR, NEW YORK, NY, 100160601

(21) Appl. No.: 10/066,340

(22) Filed: Jan. 31, 2002

Related U.S. Application Data
(60) Provisional application No. 60/265,476, filed on Jan. 31, 2001.

(51) Int. Cl. B62D 1/24

(52) U.S. Cl. 180/169

(57) ABSTRACT

A laser radar device for transmitting laser pulses, collecting the reflected data from surrounding objects, producing the three-dimensional time-dependent object representations and using these dynamic three-dimensional representations in avoiding collisions or minimizing damage resulting from collisions.

### FIELD OF THE INVENTION

This invention relates to an apparatus capable of developing three-dimensional range representations of the objects surrounding a stationary or moving vehicle, with or without the presence of obscuration, calculating the likelihood of collisions with these objects and warning the operator of these potential collisions. In particular, this invention relates to a laser radar device for transmitting laser pulses, collecting the reflected data from surrounding objects, producing the three-dimensional time dependent object representations and using these dynamic three-dimensional representations in avoiding collisions or minimizing damage resulting from collisions.

### BACKGROUND OF THE INVENTION

Modern laser radar (ladar), by accurately detecting the time-of-return of reflected signals from surrounding objects, can not only rapidly construct an accurate 3-D image of these objects but the range to these objects as well. Furthermore, with the proper laser wavelengths, the three-dimensional environment surrounding the ladar can be developed even though obscurants such as fog. It is also possible that other electromagnetic signals, such as microwaves, can be processed to yield accurate three-dimensional information. In addition Doppler-shifted frequencies from continues laser reflections can give velocity information about moving objects.

The rapid development and computer storage of the 3-D physical environment surrounding a moving vehicle can be used by an on-board processing computer to estimate time-of-impart with portions of other vehicles and warn of potential collisions, present the problem situation visually or verbally, suggest collision avoidance or minimal-damage maneuvers, or actively avoid collisions with these vehicles. This application of ladar sensors is the complement of militarily using them in the nose of a missile to select a target among a number of objects and cause a collision with a chosen spot on that target.

The computer-stored environment on the ladar-equipped vehicle can be updated very rapidly so that it always represents the current vehicle's physical environment, even during a high-speed collision avoidance maneuver. Where weather-caused (fog or snow for example) or man-made obscuration (smoke for example) is present, the ladar-based collision avoidance system (LBCOS) would be capable of enabling safe transit though the obscuration. U.S. Pat. No. 6,113,989, 3-D Imaging Laser Radar, issued Oct. 17, 2000, to the present inventors, U.S. Pat. No. 5,446,529, 3-D Imaging Underwater Laser Radar issued Aug. 29, 1995, to the present inventors and U.S. patent application Ser. No. 09/449,091, 3-D Ladar Imaging Multiple Target Laser Radar, filed Nov. 24, 1999, by the present inventors discloses 3-D ladar systems and sensors which can be used in the LBCOS.

The advantage of ladar as opposed to radar, for example, in a collision avoidance system is the shorter wavelength of the radiation which translates to the availability of compact, high-energy, short-pulse, inexpensive laser sources and the availability of compact sensors. The shorter wavelength also allows higher two dimensional resolution and more compact optics. Short pulses and more sophisticated sensors allow high-range or third-dimensional resolution. In addition, both humans and computer-based object recognition algorithms rapidly recognize 3-D images. Modern computers are now fast and inexpensive enough to process image information in real time.

In rapidly enfolding accident situations LBCOS provides distance and velocity information to the vehicle operator and/or onboard computer that is impossible for the operator to develop with his naked senses. This information and the computational processing and analysis of this information allows the operator to make damage-avoidance choices he would not otherwise know were available.

For example, consider a motor vehicle situation where a car in the lane to the right of the operator's vehicle attempts to move into the operator's lane and is unaware of the operators vehicle. LBCOS might generate a yellow flashing light with the verbal warning “look right, sound horn” or if a collision were imminent a red flashing light and, if the maneuver were safe, the verbal direction “pull left now’.

Consider another motor vehicle example: an operator in an automobile equipped with Automatic Breaking Systems (ABS) may stop as fast as possible in the direction of original motion in an accident situation because it is the only option he has time to consider. However, this may put him in danger of being hit in the rear by a heavy vehicle that he has not seen in his rear view mirror. LBCOS could alert the operator to the danger and provide the operator with a breaking pattern that avoids both collisions or provide the operator with a combined breaking and turning maneuver that avoids both collisions. Alternatively by taking over the controls, LBCOS implements a collision-avoidance or minimum-harm maneuver. When many vehicles are equipped with LBCOS, interaction between the LBCOS systems could even be more effective in averting a collision altogether or minimizing the severity of a collision.

### BRIEF DESCRIPTION OF THE PRESENT INVENTION

In the present invention electromagnetic signals reflected from objects surrounding a stationary or moving vehicle, are processed to develop a real-time, accurate, three-dimensional computational representation of the physical environment surrounding the moving vehicle. An on-board computer calculates the time of impact and warns the operator of the potential collision. Different embodiments of the invention present to the operator impact avoidance or damage minimization maneuvers. Still other embodiments of the present invention take over the controls and perform the selected maneuvers. Another embodiment of the present invention is able to penetrate obscurations such as fog and provide the same collision avoidance support to the operator with or without the obscuration present.

A preferred embodiment of the invention uses an eye-safe pulsed laser to generate electromagnetic signals and uses laser sensor detection and processing electronics to create the data that is used by the computer to develop the computation representation of the three-dimensional physical environment of the stationary or moving vehicle.

It is the object of the present invention to provide a device for collision avoidance that transmits an electromagnetic signal and creates a three-dimensional computational representation of the objects surrounding a stationary or moving vehicle by processing the electromagnetic signal reflected from the objects. The three-dimensional representation is used to predict collisions and the operator is warned of the potential danger. Collision avoidance maneuvers may be presented or automatically implemented.

The device comprises signal transmitter means for transmitting an electromagnetic signal to surrounding objects; signal receiver means for collecting reflected electromagnetic signals from the objects and developing range and two-dimension object data; output electronics means for digitizing and/or transferring the object data; data processor means for receiving the digitized data, storing the data, computing parameters indicative of potential collisions, deciding the likelihood of potential collisions and sending control signals to the drive electronics and communications system; drive electronics means for controlling the timing and biasing of the signal transmitter, the signal receiver and the output electronics and operator communication means for alerting the operator to potential collisions.

### BRIEF DESCRIPTION OF THE DRAWINGS

FIG. 1 is a block diagram of the basic system, a preferred embodiment of the Laser Radar Based Collision Avoidance System for Moving Vehicles, Automobiles, Boats and Aircraft.

FIG. 2 is a block diagram of the full system, a preferred embodiment of the Laser Radar Based Collision Avoidance System for Moving Vehicles, Automobiles, Boats and Aircraft.

FIG. 3 is a block diagram of a preferred embodiment of the LBCOS sensor.

FIG. 4 illustrates the use of LBCOS in a motor vehicle accident situation.

### DETAILED DESCRIPTION OF A PREFERRED EMBODIMENT OF THE INVENTION

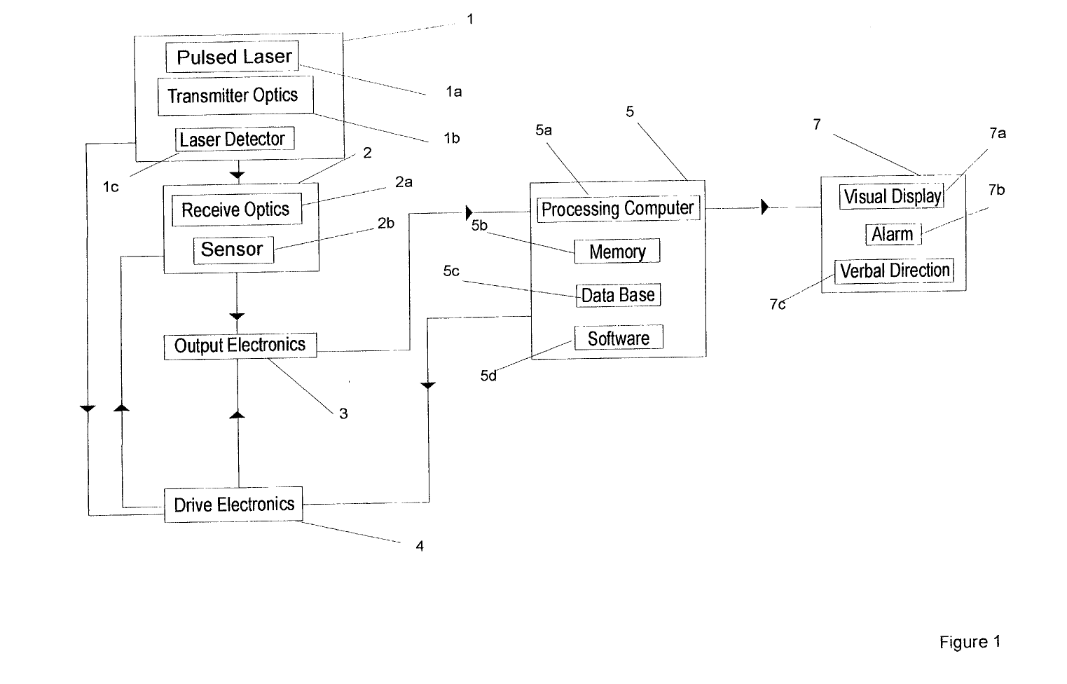

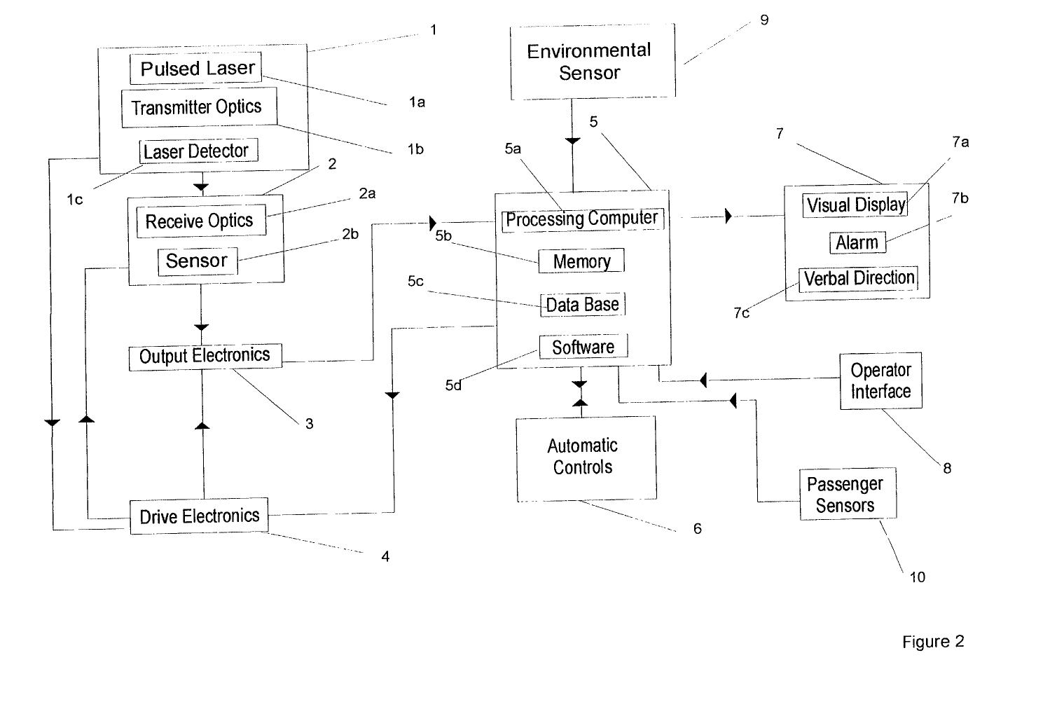

Two preferred embodiments of the present invention, the Ladar Based Collision Avoidance System (LBCOS) are depicted in FIGS. 1 and 2. LBCOS is designed to generate accurate 3-D representations of the objects, and their range, in all or a faction of the space surrounding a stationary or moving vehicle. LBCOS then processes these representations to determine collision likelihood with portions of the vehicle and the objects. The operator is alerted to a possible collision visually and/or verbally. The communication may include a suggested emergency maneuver. The visual communication with the operator may include a display of the surrounding objects on a screen with or without dynamic and range parameters such as velocity, acceleration and distance. The display may suggest a collision avoidance or minimum damage maneuver and monitor the maneuver in real time with continuous feedback to the operator. It is also possible that under predetermined circumstances LBCOS could take control of the vehicle and implement a collision avoidance or minimum damage maneuver.

Six subsystems make up the preferred embodiment of the basic invention as shown in FIG. 1; one or a plurality of signal transmitters 1 with one or a plurality of pulsed lasers 1a, transmit optics 1b, and a laser pulse detector 1c, one or a plurality of signal receivers 2 with receiver optics 2a and one or a plurality of sensors 2b, the output electronics 3, and associated drive electronics 4, the processor 5 with processing computer 5a, memory 5b, data base 5c, and software 5d, operator communications system 7 with all or some of visual display 7a, alarm 7b and verbal directions 7c. The signal transmitters 1 may be stationary or rotating. Rotation would cover a larger solid angle with a lower power laser but would not be appropriate for applications, which require the minimum response time.

The Ten subsystems make up the preferred embodiment of the invention as shown in FIG. 2; all the FIG. 1 parts as well as the operator interface 8, the environmental sensor subsystem 9, the automatic vehicle controls 6, and passenger sensors, 10. The FIG. 1 embodiment of the invention is designed to be less costly and different embodiments will have greater sophistication. For example, the communication system 7 may lack a visual display 7a component; the software 5c may be less sophisticated and processing computer 5a less powerful. In other embodiments of the invention signal transmitter and receiver will cover varying percentages of the total solid angle relevant to the vehicle application. For example, the physical environment above an automobile is not necessary but it may be for an aircraft. The environment underneath the vehicle may be relevant to a boat or aircraft but not to a motor vehicle. Additionally an individual may feel that only the physical environment to the rear of his automobile is relevant and therefore avoid the cost of full 360 degree coverage. The FIG. 2 embodiment is the more advanced system but different embodiments could have various levels of sophistication.

The pulsed laser 1 can be a laser diode with an energy per pulse measured in micro-Joules or for longer range systems the pulsed laser can be a flash lamp or diode pumped solid state laser with a pulse energy measured in Joules. A preferred embodiment is an eye-safe laser wavelength of about 1.57 um which can be produced using an optical parametric oscillator (OPO) with a NdYAG solid state laser. The preferred laser pulse detector 1a is a diode responsive to the laser wavelength supported by high bandwidth electronics. The receive optics 2a would typically have an aperture between 0.5 cm to 20 cm, depending upon the application. The transmit optics 1a may be combined with the receive optics 2a or be separate from the receive optics.

Typically the output electronics 3 would contain analog to digital converters gain and offset correction circuitry, data storage capability and may contain hardwired data processing algorithms necessary for high-speed data processing. Typically the drive electronics would contain all the sensor 2b biasing circuitry and the master clock necessary for operation of the sensor 2b. Typically the signal processor would be comprised of a computer mother board containing the processing computer 5a, typically an available integrated circuit chip such as an Intel Pentium, associated high-speed RAM memory (5b) and data buses, and a high-speed hard drive data base (5c). Typically the software 5d would be object-recognition, velocity-computation, time-of-collision-computation, decision-making, user-interface and system control software written specifically for the LBCOS application. A preferred visual display 7a is flat panel display that can also be used for the operator interface 8. Depending upon the speed requirements of the LBCOS application, portions of the software operations may be hardwired in the output electronics 3. The environmental sensor subsystem 9 would typically contain sensors to evaluate precipitation, speed and road coefficient of friction, where applicable. In some circumstances the environmental sensor subsystem 9 would be in communication with the sensors already in the vehicle which measure similar properties. The automatic controls 6 would typically contain all electronic boards necessary to communicate with the processing computer 5a and all the motors necessary to control the vehicle mechanical systems such as steering and brakes. Where automatic pilot systems already exist, such as in sophisticated aircraft, the automatic controls would link the LBCOS signal processor 5 directly to the automatic pilot computer. In some circumstances the automatic pilot computer may also be the LBCOS computer 5a. Passenger sensors 10 typically measure passenger position and may measure passenger weight and tightness of restraints such as seat belts. These sensors may also be equipped with motors and actuators to modifiy and/or activate passenger restraints such as seat belts and air bags.

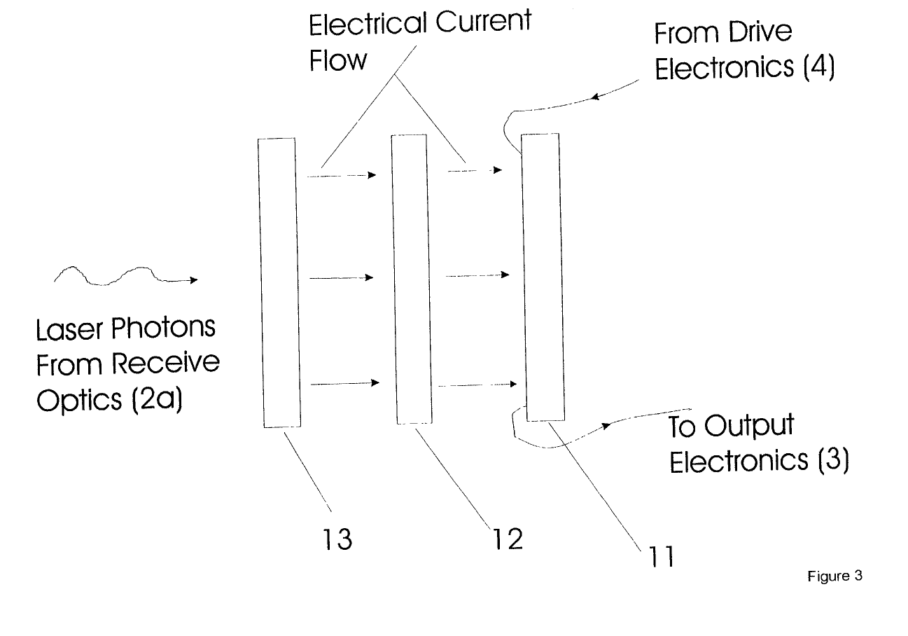

Three subsystems make up the preferred embodiment of the LBCOS sensor 2bas depicted in FIG. 3, the photon detector 13, the electron amplifier 12, and the readout integrated circuit (ROIC) 11. There may also be a plurality of ROICs 11 associated with each sensor. Electrical signals are transferred between the detector 13 and electron amplifier 12 and between the electron amplifier 12 and ROIC 11. These three subsystems may be enclosed in a vacuum tube where the detector 13 is a photocathode and the electrical signals that flow between the photon detector 13 and the amplifier 12 are vacuum electron current. In the vacuum tube sensor configuration the electron amplifier 12 can be a microchannel plate or a solid state detector or a solid state detector array used in an impact ionization mode (electrons accelerated from the photocathode to the solid state detector array). The photon detector 13 may also be combined with the amplifier 12 in an avalanche photodiode array configuration.

The ROIC 11 is typically an array of unit cells, each unit cell typically containing digital and/or analog circuitry for processing and storing data indicative of the range of objects in the vehicle's environment which, reflect laser light. The data also typically includes the peak amplitude, amplitude time history or a sequential sampling or integration of the reflected laser pulse. Typical ROIC unit cell circuitry would be high-speed counters, high-speed shift registers, storage capacitors, Schmitt triggers and amplifiers. Typical ROIC unit cell array sizes are 1×1 to 10,000×10,000. The ROIC is electrically connected to both the drive electronics 4 and the output electronics 3.

In another preferred embodiment of the LBCOS sensor 2b, the signal amplifier 12 would not be present and electrical signals are transferred directly between the detector 13 and ROIC 11 in the form of an electrical current. This transfer could be by means of metal bumps directly in contact with the detector 13 and ROIC 11. In the latter configuration, typically the detector 13 is a solid state detector array. In some circumstances the detector array may have an array of microlenses etched into the surface. Typical array sizes are 1×1 to 10,000×10,000.

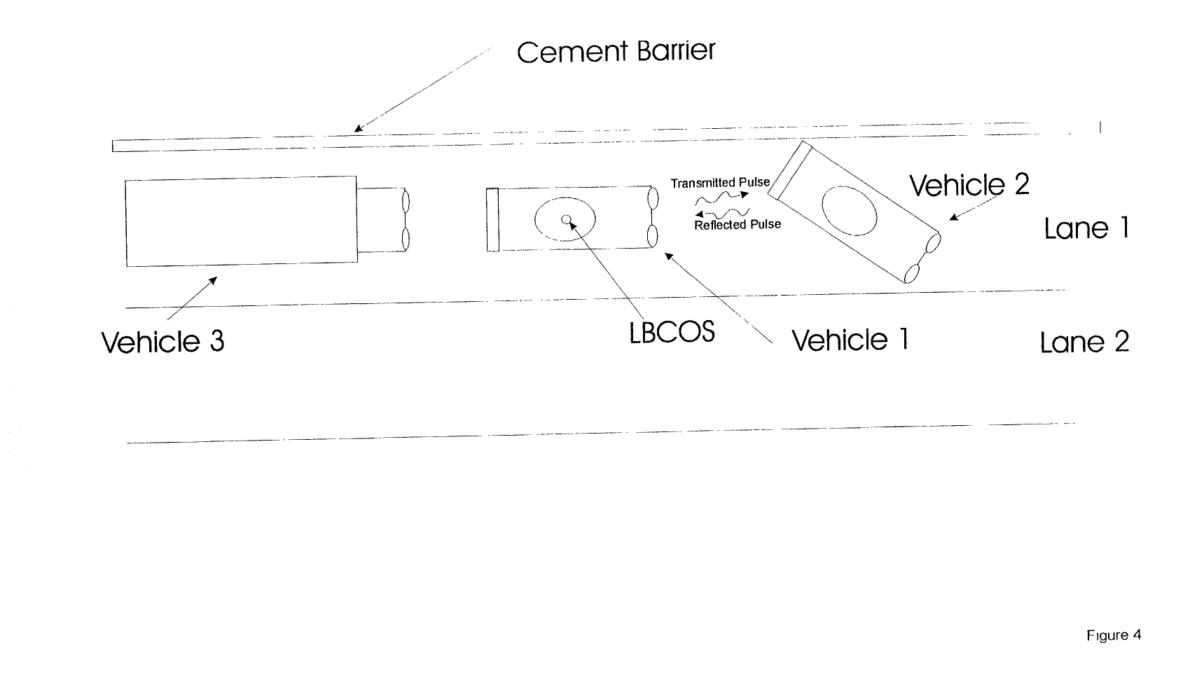

The LBCOS functions as follows: LBCOS's pulsed laser 1a is continually emitting laser pulses at a rate of about 10 to 10,000 Hz. The transmitter optics 1b directs these laser pulses in all appropriate directions in the vehicles environment. Each laser pulse is designed to illuminate all or a significant percent of the total solid angle of concern. Each time a laser 1a fires a pulse the associated laser detector 1c senses the emission and causes a master clock in the drive electronics 4 to begin operations in the associated ROIC 11 of the sensor 2b. Typically when operations begin in the associated ROIC 11, a high-speed counter would begin counting in each unit cell of the ROIC or a ramp voltage would be input to each ROIC unit cell. For underwater imaging, or when obscurants are present in the atmosphere, the ROIC unit cell input current would be sequentially integrated and stored or the input current would be converted to a voltage with a transimpedance amplifier and the voltage would be sequentially sampled and stored. Laser light reflected off surrounding vehicles (vehicle 2, vehicle 3 and the cement barrier, for example, in FIG. 4) would enter the receive optics 2a and be focused on the sensor 2b. This light would enter the detector 13 and be converted to an electrical current. If an electron amplifier 12 is present this current would be amplified. In general this form of amplification, amplification by secondary electron emission in a microchannel plate or impact ionization in a solid state material is superior to amplification in ROIC circuitry because there is very little noise associated with it. An electron amplifier 12 can reduce the power requirements of the pulsed laser 1a.

Electrical current from either the detector 13 directly or the amplifier 12 enters the unit cells of the ROIC 11. For each laser pulse, each unit cell is associated with a specific portion of the solid angle in the surrounding region of concern. Typically all or a significant portion of the unit cells on the ROIC 11 are associated with the solid angle illuminated by a single laser pulse. If the sensor scans the surrounding region then the unit-cell solid angle may change from laser pulse to laser pulse. Typically as the current pulse rises in the ROIC unit cell, a threshold is reached and the ramp voltage or range counter is stopped. The ramp voltage at threshold is stored as an analog signal. The range counter stores digital data. In addition the pulse amplitude is sampled at one or more points and stored as analog data. When a preprogrammed maximum time, determined by the expected range in LBCOS application, is reached, readout of the ROIC 11 data is begun by the drive electronics 4. This maximum time could be measured in nanoseconds to microseconds. The ROIC data is transferred to the output electronics 3 where it is corrected for gain and offset and typically where the range calculation is made. The range and unit-cell position is transferred to the processing computer 5 where the software 5d compares the data with previous frames and where a velocity and time of impact computation is made by the associated software. Typically objects are identified from the data base 5c as they enter the field of view of the LBCOS system. Identification is not generally required for each laser pulse. Typically a frame is the data gathered with one laser pulse or a minimum number of sequential laser pulses, which completely encompasses the environment of concern.

Various levels of sophistication are possible with the LBCOS. A sophisticated signal processor 5 might include object recognition algorithms to determine the nature of the potentially colliding vehicle. The signal processor data base 5c could include weight of the vehicles, stopping and maneuverability characteristics and parameters.

The operation of LBCOS is further illustrated by the FIG. 4 hypothetical accident situation. The driver in vehicle-1, a passenger car, is traveling in lane-1 with his small children in the rear seats. There are two other vehicles in his lane, lane-1, a large truck behind and another passenger car in front of vehicle-1. It is raining and vehicle-2, looses control, strikes the concrete divider and begins to spin into lane-2 while continuing to move in the direction of traffic. Without LBCOS the driver of vehicle-2 would most likely instinctively apply his brakes and stop as soon as possible, oblivious to the limited stopping ability of the truck behind him. If vehicle-1 were equipped with an automatic breaking system (ABS) and an assisted ABS, collision with vehicle-3 would almost be assured since vehicle-1 would stop in the minimum time.

Prior to the loss of control of vehicle-2, LBCOS may have identified the vehicles. It can use these vehicle characteristics to continually monitor the collision danger and may have already alerted the vehicle-1 operator of vehicle-2's and vehicle-3's range and position by means of the operator communications system 7, informing him of the danger of an minimum-distance emergency stop. As vehicle-2 goes out of control, LBCOS in vehicle-1 may first alert the operator of danger by means of the alarm 7b in his operator communications system 7. This is important for operators who may be distracted by passengers or cell phones, for example, and may not be immediately aware of the danger. LBCOS determines the danger by calculating and analyzing vehicle-2's motion and/or calculating time-to-collision at the current speeds. LBCOS may then present to the vehicle 1 operator the breaking pattern required to avoid a collision as vehicle-2 slows down in the forward direction. Also being aware of the motion of vehicle-3 and its stopping range, LBCOS would recommend by means of the visual display 7a or verbal direction 7c that the breaking pattern include collision avoidance with vehicle-3. The breaking pattern may be combined with a lateral movement into lane 2 or may include an acceleration pattern to pass vehicle 2 once it enters lane 2. Verbal directions 7c can be complemented by a visual display 7a that presents the danger situation, the suggested maneuver and real-time trajectories showing the effectiveness of the maneuver, much like a multi-dimensional video game display. The visual display can be projected on the windshield so the operator's eyes are not diverted from the accident situation.

If collisions were unavoidable LBCOS would recommend a minimum-harm maneuver. The collision-avoidance or minimum-harm maneuver would be based upon the road conditions as monitored by the environmental sensor subsystem 10, and the maneuverability and impact vulnerability of vehicle-1 as stored in the data base 5c. Vehicle-1 movements would be continually monitored by LBCOS with continuous feedback by means of the communications system 7. Alternatively, if vehicle 1 were equipped with automatic controls 6, it would implement the high-speed collision avoidance pattern, assuming the vehicle 1 operator had so indicated though the operator interface 8 prior to the trip, and return control to the operator when the vehicle was out of danger. LBCOS's automatic controls 6 may also be programmed to take control when the driver's reaction time to verbal commands is not sufficient to avoid the collision. If the vehicle were equipped with passenger sensors 9, LBCOS would take passenger position and possibly weight into account when calculating a minimum damage maneuver. Otherwise passenger position would have to be input to the processor 5 by means of the operator interface 8. LBCOS may also cause passenger sensors to tighten seat belts when warranted and deploy air bags at precisely the correct time.

What is claimed is:

1. A device for warning the operator of a stationary or moving vehicle of potential collisions with objects in his physical environment comprising
operator communication means for transmitting collision information to said operator
signal transmitter means for transmitting an electromagnetic signal to said objects;
signal receiver means for collecting reflected electromagnetic signals from said objects and developing three-dimensional object data;
output electronics means for conditioning and transferring said data;
data processor means for receiving said conditioned data, storing the data, computing parameters indicative of potential collisions from said data, deciding the likelihood of potential collisions from said parameters and sending control signals to the drive electronics and said operator communications system;
drive electronics means for controlling the timing and biasing of said signal transmitter, said signal receiver and the said output electronics.

2. The device for warning the operator of a stationary or moving vehicle of potential collisions with objects in his physical environment of claim 1 wherein said electromagnetic signal is a laser pulse.

3. The device for warning the operator of a stationary or moving vehicle of potential collisions with objects in his physical environment of claims 1 and 2 wherein the signal transmitter comprises;
means for producing one or a plurality of laser pulse;
optics means for concentrating the laser light in a solid angle consistent with the power of the laser and useful range of the invention;
laser detector means for detecting the emission of the laser pulse and transferring a signal representative of that information to the said drive electronics.

4. The device for warning the operator of a stationary or moving vehicle of potential collisions with objects in his physical environment of claims 1, 2 and 3 wherein the signal receiver comprises;
optics means for collecting said reflected laser light concentrating the laser light on sensor means;
sensor means for converting said electromagnetic signals to an electrical current;
unit cell electronics means for storing signals corresponding to said electrical current in a two-dimensional array, the two-dimensional array corresponding to the two dimensional surface of the said objects, with information indicative of the time of return of the said reflected electromagnetic signal from the said objects;
output driver electronics circuitry means for transferring said stored signals to said output electronics.

5. The device for warning the operator of a stationary or moving vehicle of potential collisions with objects in his physical environment of claims 1, 2, 3 and 4 wherein the sensor means includes electron amplifier means.

6. The device for warning the operator of a stationary or moving vehicle of potential collisions with objects in his physical environment of claims 1, 2, 3, 4 and 5 wherein the said electron amplifier means is a microchannel plate.

7. The device for warning the operator of a stationary or moving vehicle of potential collisions with objects in his physical environment of claims 1, 2, 3, 4 and 5 wherein the said electron amplifier means is a solid state detector array used in an impact ionization mode.

8. The device for warning the operator of a stationary or moving vehicle of potential collisions with objects in his physical environment of claims 1, 2, 3 and 4 wherein the sensor means includes detector means.

9. The device for warning the operator of a stationary or moving vehicle of potential collisions with objects in his physical environment of claims 1, 2, 3, 4 and 8 wherein the said detector means is a photocathode.

10. The device for warning the operator of a stationary or moving vehicle of potential collisions with objects in his physical environment of claims 1, 2, 3, 4 and 8 wherein the said detector means is a solid state detector array.

11. The device for warning the operator of a stationary or moving vehicle of potential collisions with objects in his physical environment of claims 1, 2, 3 and 4 wherein the sensor means includes one or a plurality of readout integrated circuit means.

12. The device for warning the operator of a stationary or moving vehicle of potential collisions with objects in his physical environment of claims 1, 2, 3, 4 and 11 wherein the said integrated circuit means includes an array of unit cell circuits.

13. The device for warning the operator of a stationary or moving vehicle of potential collisions with objects in his physical environment of claims 1, 2, 3, 4, 11 and 12, wherein the said unit cell circuits includes circuit means for developing data indicative of the flight time of a laser pulse to a portion of an object and back to the device.

14. The device for warning the operator of a stationary or moving vehicle of potential collisions with objects in his physical environment of claims 1, 2, 3, 4, 11, 12 and 13, wherein the said circuit means for developing data indicative of the flight time of a laser pulse to a portion of an object and back to the device includes a digital range counter.

15. The device for warning the operator of a stationary or moving vehicle of potential collisions with objects in his physical environment of claims 1, 2, 3, 4, 11, 12 and 13, wherein the said circuit means for developing data indicative of the flight time of a laser pulse to a portion of an object and back to the device includes analog, pulse-shape-sampling circuitry.

16. The device for warning the operator of a stationary or moving vehicle of potential collisions with objects in his physical environment of claims 1, 2, 3, 4, 11, 12 and 13, wherein the said circuit means for developing data indicative of the flight time of a laser pulse to a portion of an object and back to the device includes Schmitt Trigger circuitry.

17. The device for warning the operator of a stationary or moving vehicle of potential collisions with objects in his physical environment of claims 1, 2, 3, 4, 11, 12 and 13, wherein the said circuit means for developing data indicative of the flight time of a laser pulse to a portion of an object and back to the device includes Transimpedance Amplifier circuitry.

18. The device for warning the operator of a stationary or moving vehicle of potential collisions with objects in his physical environment of claim 1 wherein said operator communication means includes a flat panel display and/or a windshield projection.

19. The device for warning the operator of a stationary or moving vehicle of potential collisions with objects in his physical environment of claim 1 wherein said operator communication means are verbal commands.

20. The device for warning the operator of a stationary or moving vehicle of potential collisions with objects in his physical environment of claim 1 wherein said operator communication means includes a warning buzzer or alarm.

21. The device for warning the operator of a stationary or moving vehicle of potential collisions with objects in his physical environment of claim 1 wherein said output electronics means includes analog to digital converters.

22. The device for warning the operator of a stationary or moving vehicle of potential collisions with objects in his physical environment of claim 1 wherein said output electronics means includes gain and offset correction circuitry.

23. The device for warning the operator of a stationary or moving vehicle of potential collisions with objects in his physical environment of claim 1 wherein said output electronics means includes circuitry for implementing range calculations using said data.

24. The device for warning the operator of a stationary or moving vehicle of potential collisions with objects in his physical environment of claims 1 and 23 wherein said output electronics means includes circuitry for implementing time of impact calculations.

25. The device for warning the operator of a stationary or moving vehicle of potential collisions with objects in his physical environment of claim 1, 23 and 24 wherein said output electronics means includes circuitry for implementing collision avoidance decisions.

26. The device for warning the operator of a stationary or moving vehicle of potential collisions with objects in his physical environment of claim 1 wherein said data processor means includes a digital computer.

27. The device for warning the operator of a stationary or moving vehicle of potential collisions with objects in his physical environment of claim 1 wherein said data processor means includes range computation software.

28. The device for warning the operator of a stationary or moving vehicle of potential collisions with objects in his physical environment of claim 1 wherein said data processor means includes time-of-impact computation software.

29. The device for warning the operator of a stationary or moving vehicle of potential collisions with objects in his physical environment of claim 1 wherein said data processor means includes object recognition software.

30. The device for warning the operator of a stationary or moving vehicle of potential collisions with objects in his physical environment of claims 1 and 29 wherein said object recognition software is three-dimensional object recognition software.

31. The device for warning the operator of a stationary or moving vehicle of potential collisions with objects in his physical environment of claim 1 wherein said data processor means includes collision-avoidance calculation software.

32. The device for warning the operator of a stationary or moving vehicle of potential collisions with objects in his physical environment of claim 1 wherein said data processor means includes minimum-damage calculation software.

33. The device for warning the operator of a stationary or moving vehicle of potential collisions with objects in his physical environment of claim 1 wherein said drive electronics means includes a master clock.

34. The device for warning the operator of a stationary or moving vehicle of potential collisions with objects in his physical environment of claim 1 which also comprises environmental sensor system means for obtaining parameters relevant to collision avoidance or damage minimization decisions.

35. The device for warning the operator of a stationary or moving vehicle of potential collisions with objects in his physical environment of claims 1 and 34 wherein said environmental sensor system means includes a precipitation monitor.

36. The device for warning the operator of a stationary or moving vehicle of potential collisions with objects in his physical environment of claims 1 and 34 wherein said environmental sensor system means includes a vehicle speed indicator.

37. The device for warning the operator of a stationary or moving vehicle of potential collisions with objects in his physical environment of claims 1 and 34 wherein said environmental sensor system means includes a coefficient of friction indicator.

38. The device for warning the operator of a stationary or moving vehicle of potential collisions with objects in his physical environment of claim 1 which also comprises automatic control means for implementing collision avoidance or damage minimization maneuvers.

39. The device for warning the operator of a stationary or moving vehicle of potential collisions with objects in his physical environment of claim 1 which also comprises passenger sensor means for obtaining passenger parameters that can be used for collision avoidance maneuvers, damage minimization maneuvers and optimal activation of passenger protection devices.

40. The device for warning the operator of a stationary or moving vehicle of potential collisions with objects in his physical environment of claims 1 and 39 wherein said passenger sensor means includes passenger position indicators.

41. The device for warning the operator of a stationary or moving vehicle of potential collisions with objects in his physical environment of claims 1 and 39 wherein said passenger sensor means includes passenger weight indicators.

42. The device for warning the operator of a stationary or moving vehicle of potential collisions with objects in his physical environment of claims 1 and 39 wherein said passenger sensor means includes means for activating, adjusting or modifying passenger restraints.

43. The device for warning the operator of a stationary or moving vehicle of potential collisions with objects in his physical environment of claim 1 which also comprises operator interface means for inputting information into the said data processor means.

44. The device for warning the operator of a stationary or moving vehicle of potential collisions with objects in his physical environment of claims 1 and 43 wherein the said operator interface means includes a flat panel display.

45. The device for warning the operator of a stationary or moving vehicle of potential collisions with objects in his physical environment of claim 1 wherein the said data processor means includes database means.

46. The device for warning the operator of a stationary or moving vehicle of potential collisions with objects in his physical environment of claims 1, 30 and 45 wherein the said database means includes vehicle identification parameters which can be used by the said object recognition software.

47. The device for warning the operator of a stationary or moving vehicle of potential collisions with objects in his physical environment of claims 1, 31 and 45 wherein the said database means includes vehicle maneuverability parameters which can be used by the said collision-avoidance calculation software.

48. The device for warning the operator of a stationary or moving vehicle of potential collisions with objects in his physical environment of claim 1 wherein said electromagnetic signal is a continuous laser.

49. The device for warning the operator of a stationary or moving vehicle of potential collisions with objects in his physical environment of claims 1 and 48 wherein said signal receiver can process Doppler-shifted laser signals.

50. The device for warning the operator of a stationary or moving vehicle of potential collisions with objects in his physical environment of claim 1 wherein said electromagnetic signal is a microwave signal.

51. The device for warning the operator of a stationary or moving vehicle of potential collisions with objects in his physical environment of claims 1, 2, 3, 4, 5 and 8 wherein the said electron amplifier means is a solid state detector array used in an impact ionization mode.

52. The device for warning the operator of a stationary or moving vehicle of potential collisions with objects in his physical environment of claims 1, 2, 3, 4, 11 and 12, wherein the said unit cell circuits includes circuit means for sequentially integrating and storing the current input to the unit cell from the detector.

53. The device for warning the operator of a stationary or moving vehicle of potential collisions with objects in his physical environment of claims 1, 2, 3, 4, 11 and 12, wherein the said unit cell circuits includes circuit means for converting the current input from the detector to a time dependent voltage and sequentially sampling and storing this voltage.

54. A method for warning the operator of a stationary or moving vehicle of potential collisions with objects in his physical environment, where the environment may include obscuration, comprising the steps of:
generating a series of pulses of light;
transmitting said light into said environment;
collecting light from said environment during the time of transmission and reflection of said light from said objects;
providing electrical signals from a plurality of positions on the objects with a single light pulse,
storing said electrical signals on a plurality of unit cells corresponding to the said plurality of positions on said objects,
providing signals from said storage means,
converting the signals stored on said storage means to three dimensional images of the objects;
processing said images to calculate the likelihood of object collisions with said vehicle;
communicating the results of said calculation to the vehicle operator

55. The method for warning the operator of a stationary or moving vehicle of potential collisions with objects in his physical environment of claim 54, wherein the electrical signals correspond to the transit time of the light to the object positions and back to the transmitter.

56. The method for warning the operator of a stationary or moving vehicle of potential collisions with objects in his physical environment of claim 54, wherein the said processing includes calculation of collision avoidance maneuvers.

57. The method for warning the operator of a stationary or moving vehicle of potential collisions with objects in his physical environment of claims 54 and 56, wherein the said communication includes communication of collision avoidance maneuvers.

58. The method for warning the operator of a stationary or moving vehicle of potential collisions with objects in his physical environment of claim 54, wherein the said processing includes calculation of minimum-damage maneuvers.

59. The method for warning the operator of a stationary or moving vehicle of potential collisions with objects in his physical environment of claims 54 and 58, wherein the said communication includes communication of minimum-damage maneuvers.
